(19) United States
(12) Patent Application Publication
(10) Pub. No.: US 2006/0251334 A1
(43) Pub. Date: Nov. 9, 2006

(54) Balance function diagnostic system and method

(76) Inventors: Toshihiko Oba, Oita (JP); Soichiro Matsushita, Tokyo (JP)

Correspondence Address: BRINKS HOFER GILSON & LIONE, P.O. BOX 10395, CHICAGO, IL, 60610, US

(21) Appl. No.: 11/251,570

(22) Filed: Oct. 13, 2005

Related U.S. Application Data
(63) Continuation-in-part of application No. PCT/JP04/07402, filed on May 24, 2004.
(60) Provisional application No. 60/618,967, filed on Oct. 15, 2004.

(30) Foreign Application Priority Data
May 22, 2003 (JP) 2003-145400

(51) Int. Cl. G06K 9/40

(52) U.S. Cl. 382/275

(57) ABSTRACT

A balance diagnostic apparatus and system is given a portable size and weight and also expands the places of use and methods of use to a large range, thus achieving an environment where anyone can undergo diagnosis of balance disorders at any time or any place. At least motion sensor means 10 and motion storage means 18 that temporarily stores signals that represent motion from the motion sensor means 10 are worn on the body of the user. Moreover, once the motion situation is stored in the motion storage means 18, the input of the motion diagnosis means 12 is connected to the output of the motion storage means 18 to obtain the output of diagnostic results with this balance function diagnostic system.

### REFERENCE TO EARLIER FILED APPLICATIONS

This application is a continuation-in-part of prior PCT Patent Application No. PCT/JP2004/007402, filed May 24, 2004, which claims priority to JP Patent Application No. 2003-145400, filed May 22, 2003, and Applicants claim the benefit under §119(e) of U.S. Provisional Application No. 60/618,967, filed Oct. 15, 2004, the entire contents of all of which are incorporated by reference herein.

### BACKGROUND

The present invention relates to an apparatus that is worn on the body of the user and that is used in a system that supports therapeutic knowledge-based diagnosis of the functions of balance by obtaining information on unconsciously occurring motions such as sway or inclination of the body, and to the system. This system is effective in diagnosing not only diseases of the balance function and also states of functional deterioration such as the state of fatigue, for example.

In the diagnosis of balance disorders including dizziness or vertigo, the publication of unexamined Japanese patent application (Kokai) No. JP-A 8-215176, for example, presents a known examination apparatus and system called a Stabilometer that calculates the distribution of weight applied to the soles of the feet together with the time that the user is standing straight up, thereby analyzing unconscious motions of the body (JP-A 8-215176).

With this system, the user steps onto an apparatus that resembles a weighing scale for home use, so that the distribution of force acting on the horizontal surface of the scale is measured by strain gages or other force sensors, and thus the diagnosis is performed by merely having the user stand on the apparatus. The diagnosis of balance disorders is performed based on the principle of measuring the distribution of gravity acting on the soles of the feet.

The information measured by this apparatus is the change over time in the position of the center of gravity of the body as estimated by the distribution of force applied to the soles of the feet. Motion patterns are collected in advance from those of healthy persons and persons with characteristic diseases related to balance function disorders. These motion patterns are collected over a fixed period of time of 30 seconds or 60 seconds for each of the states of eyes being open and eyes being closed. When a new motion pattern is collected from a user, a diagnosis of balance function is performed by statistical identification of a motion pattern from the pre-collected motion patterns which is closest to the new motion pattern collected from the user.

The apparatus and diagnostic method based on this scheme is listed in Shakai Hoken Shinry\overline{o} H\overline{o}sh\overline{u} ni Kan-suru Ika Tens\overline{u} Hy\overline{o} no Kaishaku [Interpretation of the Medical Score Table Pertaining to Social Insurance Medical Treatment and Diagnosis Remuneration] published by the Ministry of Health, Labour and Welfare (Ministry of Health and Welfare at the time of publication) on Mar. 16, 1994 (Notification No. 25 of the Health Insurance Bureau), and is being used for diagnosis in insurance and medical treatment facilities within Japan.

In the diagnosis of sense of balance function based on the prior art, the user stands upon the horizontal surface of a scale-like apparatus and the distribution of weight applied to the soles of the feet is measured, so the apparatus must have a horizontal surface of at least sufficient surface area to stand on with both feet. In addition, it must be able to withstand a weight of at least several dozen kilograms while also being able to detect the slight unconscious motions (typically on the order of several millimeters when taken as the distance of motion of the position of the center of gravity). Thus when sensors such as the strain gages currently in use are used, it is indispensable for the examination apparatus to have a certain amount of weight.

To wit, it is necessary to make the horizontal surface out of a material that both prevents damage to the apparatus due to body weight and also reversibly bends under body weight with good reproducibility, so a heavy metal plate is typically used as this material.

Moreover, from the nature of the apparatus in that it measures the weight distribution, it is preferable that gravity act in the direction perpendicular to the horizontal surface upon which the user stands, so it is necessary for the installation position of the measurement apparatus to be calibrated in advance with respect to gravity applied to the horizontal surface.

Due to the above, from the standpoint of limitations on the size and weight of the apparatus and the installation location, it is quite difficult for a conventional sense of balance function diagnostic apparatus to be made portable and used in everyday life. In addition, due to the principle of operation of the apparatus, it cannot be used in locations without gravity.

Moreover, with a diagnostic apparatus based on the prior art, the user must be standing on both feet for at least a fixed period of time, for example, 30 seconds or 60 seconds. For this reason, the people who can be diagnosed are limited to those who can stand straight on both feet, so it is a diagnostic method that cannot be used on persons who may have a disorder of the sense of balance function, but have difficulty maintaining the standing position for long periods of time, or persons who are not easily measured in the standing position due to other symptoms.

In this manner, with a sense of balance diagnostic apparatus according to the prior art, the situation is not such that anyone can undergo diagnosis easily at any time or any place.

### SUMMARY

Thus, the present invention came about in order to solve the aforementioned problems and an object is to make the diagnostic apparatus one of a portable size and weight and also expand the places of use and methods of use to a much greater range than those based on the prior art, thus achieving an environment where anyone can undergo diagnosis of balance disorders at any time or any place.

The present invention utilizes the measurement of motion at characteristic locations on the body, namely the positions of the head and waist of the user where the so-called “vertigo or dizziness” phenomenon acts, thus using motion sensor means for measuring these motions. In addition, motion diagnosis means that processes signals from the motion sensor means and gives appropriate diagnostic results is also used.

In addition, in a configuration where the motion diagnosis means is not portable but rather is installed such that it is physically isolated from the motion sensor means, by making motion storage means, which temporarily stores signals from the motion sensor means using a semiconductor memory or other storage device, portable together with the motion sensor means, it is possible to adopt a configuration where diagnosis is performed by having the user carry only an even more compact and lighter apparatus.

The present invention provides a balance function diagnostic system comprising a portable terminal unit that can be worn on the body of the user and an analytical apparatus that analyzes the data from this portable terminal unit, where the portable terminal unit includes motion sensor means that detects the motion of the body of the user, the analytical apparatus includes motion diagnosis means that processes signals from the motion sensor means and performs diagnosis of balance function based on prerecorded motion diagnosis information, and where the balance function diagnostic system is constituted such that it is able to analyze the motion of the user and output diagnostic information related to balance function.

The “detection of motion” includes the detection of characteristic motions that appear together with disorder or deterioration of the sense of balance, including for example, speed in linear motion, acceleration, angular velocity around various central axes of rotation, and the like.

In addition, the present invention provides a balance function diagnostic system comprising a portable terminal unit that can be worn on the body of the user and an analytical apparatus that analyzes the data from this portable terminal unit, where the portable terminal unit includes motion sensor means that detects the motion of the body of the user and motion storage means that stores signals from the motion sensor means, the analytical apparatus includes motion diagnosis means that processes signals from the motion sensor means and performs diagnosis of balance function based on prerecorded motion diagnosis information, and where the system is constituted such that it is able to analyze the motion of the user and output diagnostic information related to balance function.

In addition, the present invention provides a balance function diagnostic system comprising a portable terminal unit that can be worn on the body of the user and an analytical apparatus that analyzes the data from this portable terminal unit, where the portable terminal unit includes motion sensor means that detects the motion of the body of the user and motion information sending means that sends signals from the motion sensor means wirelessly to the outside, the analytical apparatus includes motion information receiving means that receives signals from the motion information transmission means and obtains signals from the motion sensor means, motion diagnosis means that processes signals from the motion sensor means and performs diagnosis of balance function based on prerecorded motion diagnosis information, and where the system is constituted such that it is able to analyze the motion of the user and output diagnostic information related to balance function.

In addition, the motion diagnosis means may further comprise stimulus generation means that applies sensory stimuli to the user, so by sharing information related to the characteristics of sensory stimuli applied to the user by the stimulus generation means in the motion diagnosis means, it is possible to analyze signals from the motion sensor means with respect to specific stimuli and output diagnostic information for the balance function.

In addition, the present invention provides a portable terminal unit used in a balance function diagnostic system having a constitution as described above, where the motion sensor means is constituted such that it can be mounted on the top of the head of the user, and where the portable terminal unit is constituted so as to have detection sensitivity in at least the anterior/posterior direction and the left/right direction with respect to the head.

In addition, the present invention provides a portable terminal unit used in a balance function diagnostic system having a constitution as described above, where the motion sensor means is constituted such that it can be mounted in the waist area of the user, and where the portable terminal unit is constituted so as to have detection sensitivity in at least the anterior/posterior direction and the left/right direction with respect to the centerline of the body of the user.

In addition, the present invention provides a diagnostic apparatus used in a balance function diagnostic system having a constitution as described above.

In addition, the present invention provides a computer-readable program for the purpose of executing the motion analysis means in the diagnostic apparatus having a constitution as described above. This program can also be stored on recording media.

### BRIEF DESCRIPTION OF THE DRAWINGS

FIG. 1 is a block diagram of a balance function diagnostic system.

FIG. 2 is a block diagram of a balance function diagnostic system.

FIG. 3 is a block diagram of a balance function diagnostic system.

FIG. 4 is a block diagram of a balance function diagnostic system.

FIG. 5 is a block diagram of a balance function diagnostic system.

FIG. 6 is a block diagram of a balance function diagnostic system.

FIG. 7 is a functional block diagram illustrating the constitution of a balance function diagnostic system.

FIG. 8 is a flowchart of one example of the processing of information by a balance function diagnostic system.

FIG. 9 is a diagram illustrating the acceleration trace pattern of a user obtained from an acceleration sensor.

FIG. 10 is a diagram illustrating an example of finding the surface area based on the aforementioned acceleration trace pattern.

FIG. 11 is a diagram illustrating an example of finding the total trace length from the aforementioned acceleration trace pattern.

FIG. 12 is a diagram illustrating the results of a Fourier transform from the time signal f(t) to the frequency function F(ω).

FIG. 13 is a diagram illustrating an exemplary circuit design.

FIG. 14 is a photograph illustrating an exemplary headset device.

FIG. 15 is a photograph illustrating a setup of the sense of balance diagnosis system with the headset device.

FIG. 16 is a screenshot illustrating a measurement trace of a two-dimensional acceleration plot.

FIG. 17 is a diagram illustrating a trace of the estimated COG position derived from the stabilometry method.

FIG. 18 is a diagram illustrating a trace of acceleration plots obtained by the headset device.

FIG. 19 is a chart illustrating trace length versus tiredness.

FIG. 20 is a chart illustrating a series of the total length data when the user's eyes are closed.

FIG. 21 is a chart illustrating a relationship between the total length of acceleration trace plots and the total kinetic energy for a determined frequency range.

FIG. 22 is a chart illustrating a total trace length versus a y-axis high frequency portion of kinetic energy.

### DETAILED DESCRIPTION

In the field of otolaryngology (dealing with problems of ENT: ear, nose, and throat), a measurement on the position of the center of gravity (COG) may be used to diagnose one's sense of balance. While considering the scene of the COG-based diagnosis, it may be determined that other parts of the body, such as the head of the user (patient), moves as the COG moves. If some accelerometers or other motion sensors are attached on the user's head or other part of the body, it may be possible to diagnose the sense of balance without using a force plate. A combination of motion sensors and signal processing circuitry is described that performs data acquisition and recognition tasks can be implemented in a wearable device. An all-in-one diagnosis system may allow daily medical checks to be performed on ambulatory subjects, regardless of when and where the user is located.

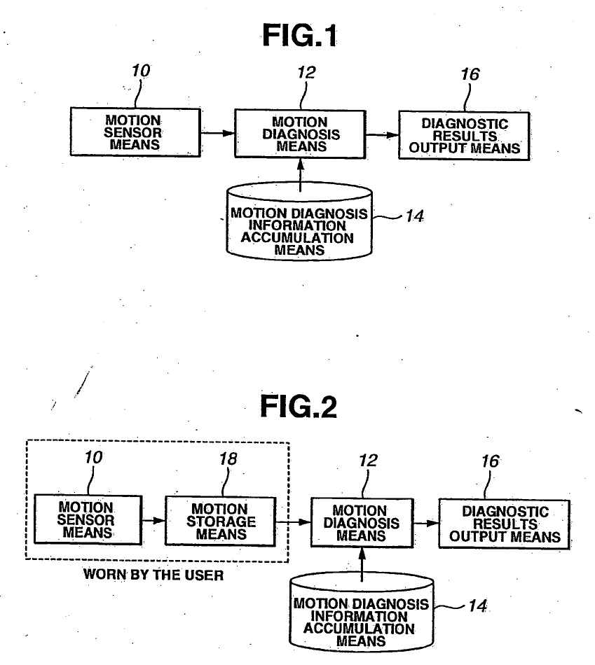

FIG. 1 illustrates a first embodiment, where signals representing the motion of the body of the user detected by motion sensor means 10 are provided as input to motion diagnosis means 12. The motion diagnosis means 12 calculates, from the signals that represent motion, physical characteristic quantities which are various parameters stored in motion diagnosis information accumulation means 14 that describe physical motion, such as the acceleration, velocity, displacement and frequency components, for example. In addition, by performing a comparison with prerecorded physical characteristic quantities acquired from healthy persons and non-healthy persons with specific disorders of balance function, namely by comparing with motion diagnosis information, the diagnosis of balance function is performed. Moreover the diagnostic results are output via diagnostic results output means 16.

In this embodiment, on the body of the user is worn at least the motion sensor means 10 but other constituent elements, namely the motion diagnosis means 12, motion diagnosis information accumulation means 14 and diagnostic results output means 16 need not necessarily be worn on the body of the user.

However, in the case that the motion sensor means 10 and the motion diagnosis means 12 are connected by physical wiring or namely electrical signal wiring, there is the possibility that the presence of wiring may impede the natural motions of the user, so it is more preferable that all of the means be worn on the body of the user.

FIG. 2 illustrates a second embodiment of the present invention, where at least motion sensor means 10 and motion storage means 18 that temporarily stores signals representing motion from the motion sensor means 10 are worn on the body of the user. Moreover, once the situation of motion is stored in the motion storage means 18, by connecting the output of the motion storage means 18 to the input of the motion diagnosis means 12, diagnostic result output is obtained in the same manner as the procedure recited in the first embodiment.

In this embodiment, the only constituent elements that must be on the body of the user are the motion sensor means 10 and the motion storage means 18, and the electrical signal wiring or other physical wiring need be provided between the motion storage means 18 and the motion diagnosis means 12 only after the measurement of the motion of the user is complete, so it is possible to make the measurements required for diagnosis without impeding the natural motions of the user.

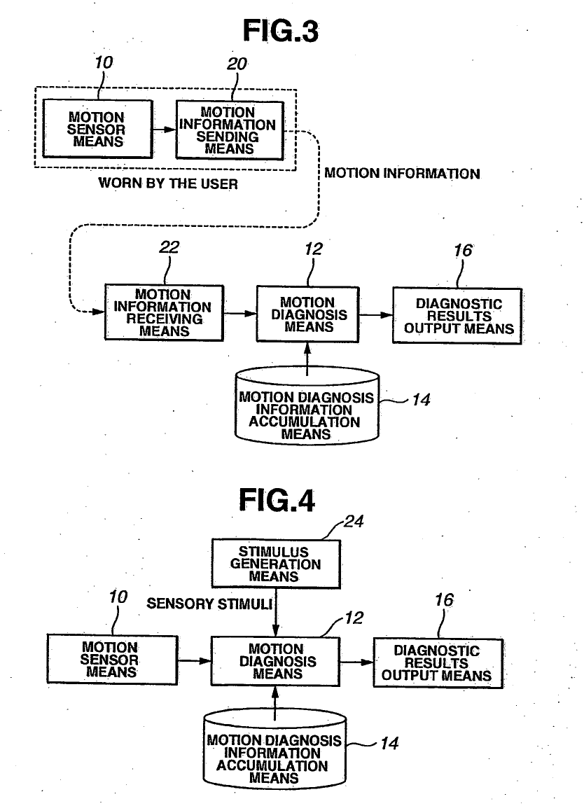

FIG. 3 illustrates a third embodiment of the present invention, where the motion storage means 18 in the second embodiment is replaced by motion information sending means 20 worn by the user and motion information receiving means 22 that need not necessarily be worn by the user, so that motion information is transmitted between the two by a wireless method as a motion information signal.

In this embodiment, the only constituent elements that must be worn on the body of the user are the motion sensor means 10 and the motion information sending means 20, while the other constituent elements, namely the motion information receiving means 22, motion diagnosis means 12, motion diagnosis information accumulation means 14 and diagnostic results output means 16 need not necessarily be worn on the body of the user.

In this embodiment, the equipment worn on the body of the user is minimized while the measured information is transmitted in real time to outside equipment that performs the motion diagnosis, so it is possible to perform motion diagnosis that requires real-time response without impeding the natural motions of the user.

FIG. 4 illustrates a fourth embodiment of the present invention, where the balance function diagnostic system according to the first embodiment is combined with stimulus generation means 24, which actively applies sensory stimuli to the user and is coupled to the motion diagnosis means 12.

The sensory stimuli generated by the stimulus generation means 24 may be, for example, visual stimuli given to the user by the projection of moving images onto a large screen, a light source that is given varying intensity, a head-mounted display worn on the head of the user, or other presentation of images from equipment that projects images near the eye, auditory stimuli including stereo or other three-dimensional stimuli given in an auditory manner, or active stimuli that act with physical force on the body of the user, such as pressure applied on the back of the user, for example.

In this embodiment, in addition to the stimulus generation means 24 which gives these kinds of stimuli, by transmitting to the motion diagnosis means 12 information as to when the stimulus generation means 24 gave what kind of stimuli to the user, it is possible to easily identify the corresponding signals from the motion sensor, thus making active diagnosis of balance function possible.

In addition, the stimulus generation means 24 according to this embodiment may also be used together with the second or third embodiment of the present invention, and in either case the weight of equipment that must be worn on the body of the user can be reduced and also the natural motions of the user are not impeded by physical electrical signal wiring or the like, so it is possible to perform motion diagnosis of the user under application of external stimuli in a more natural situation.

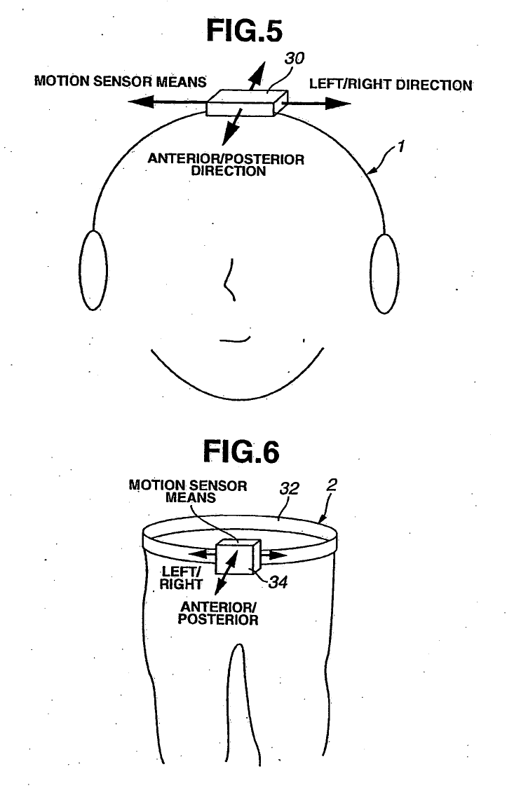

FIG. 5 illustrates an example of the balance function diagnostic apparatus 1 according to a fifth embodiment of the present invention, being an example where a motion sensor 30 consists of force sensors or acceleration sensors, mounted on the top of the head, that are sensitive in the anterior/posterior direction and the left/right direction with respect to the head.

Note that at the time of measurement, it is preferable that the head of the user be in the same orientation as when standing straight with respect to the ground, namely the top of the head should be furthest from the ground. In the diagnosis of balance function, measurement of physical sway of the head is effective, but with this embodiment, it is possible to measure not only coordinate translation of the head in the anterior/posterior direction and in the left/right direction, but also the angle of the top of the head with respect to the horizontal plane of the ground, and namely the change in orientation of the head can also be acquired as motion information supplied for diagnosis. To wit, by using acceleration sensors that are sensitive with respect to gravity (static accelerometers), it is possible to calculate the angle of the top of the head with respect to the gravity direction.

Now, taking θ to be the angle of the top of the head with respect to the horizontal plane of the ground, G to be the acceleration due to gravity and a to be the acceleration measured by the acceleration sensor, the relationship
a=G·sin θ (1)
holds true. Here, if θ is extremely small, specifically when it is smaller than approximately 5°, then the relationship sin θ≈θ holds true (provided that the units of θ are radians), so the relationship can be expressed as:
a≈G·θ

This means that when the user wears the sensor on the top of the head, as long as the angle with respect to the ground can be maintained within an error range of roughly 5° or less, then the change in orientation of the head of the user, namely the fluctuation in θ can be read as the fluctuation in the measured acceleration a. Accordingly, even without calibrating the relationship between the orientation (angle) and acceleration each time the sensor is mounted on the top of the head, sway of the top of the head can be measured with good reproducibility.

Note that since the acceleration sensor is sensitive to the angle with respect to the ground, or namely to the degree of action of gravity, the acceleration thus measured includes that due to linear motion and that corresponding to the change in angle. Thus, in order to make more accurate measurement possible, for the change in angle, it is possible to use a gyro sensor which is a sensor sensitive to rotary motion and thus achieve isolation from linear motion. However, in actual measurements, the change in the angle with respect to the ground is mostly a slow change in contrast to linear motion, so by extracting from the signal from the acceleration sensor only the high-frequency components, namely the components that change with a period of roughly 2 cycles per second or greater, it is possible to perform appropriate diagnosis. In this case, the diagnosis is performed after removing as noise the signal components output from the acceleration sensor (e.g., the low-frequency components) due to the change in posture of the user.

In addition, regarding coordinate translation of the top of the head in the forward and backward, left and right directions also, if the dispersion in the mounting position of the motion sensor on the top of the head is less than ±5° as an angle of inclination, because sin 5°≈0.08, it is possible to measure the acceleration of motion in the forward and backward, left and right directions to an error of roughly 10% or less.

In addition, with the motion sensor mounted on the top of the head, limitations due to the clothing of the user are few and by adopting a constitution like that of a hair band or headphones, it has an advantage that it can be used easily by anyone.

Note that the sensors that can be used as motion sensors include acceleration sensors that calculate acceleration by measuring the forces acting on a weight in the interior of the sensor, along with gyro sensors that measure the angular velocity, but from the nature of measuring fluctuations at the top of the head, it is preferable to measure motion in at least the two directions of forward and backward/left and right with respect to the orientation of the top of the head in the standing position.

### Embodiment 6

FIG. 6 illustrates an example of the balance function diagnostic apparatus 2 according to a sixth embodiment of the present invention, being an example where motion sensor means 34 consists of a motion sensor worn at the waist of the user and secured to the front of the body at the waist using a belt-like jig 32.

The waist is the part of the body that serves as the base for nearly all of the motions of the human body, so random motions that are meaningless in the diagnosis of balance function occur less readily than in the extremities such as the hands or feet and thus highly reliable motion information is obtained. Accordingly, while the motion sensor is placed on the front of the body at the waist in this embodiment, similar meritorious effects can be obtained even if it is placed at the center of the back.

Measurement of body sway is effective in the diagnosis of balance function, so measurement of the forward and backward/left and right motions of the waist area which is near the center of the body is effective, and thus it is preferable to use acceleration sensors or angular velocity sensors that are sensitive in these respective directions.

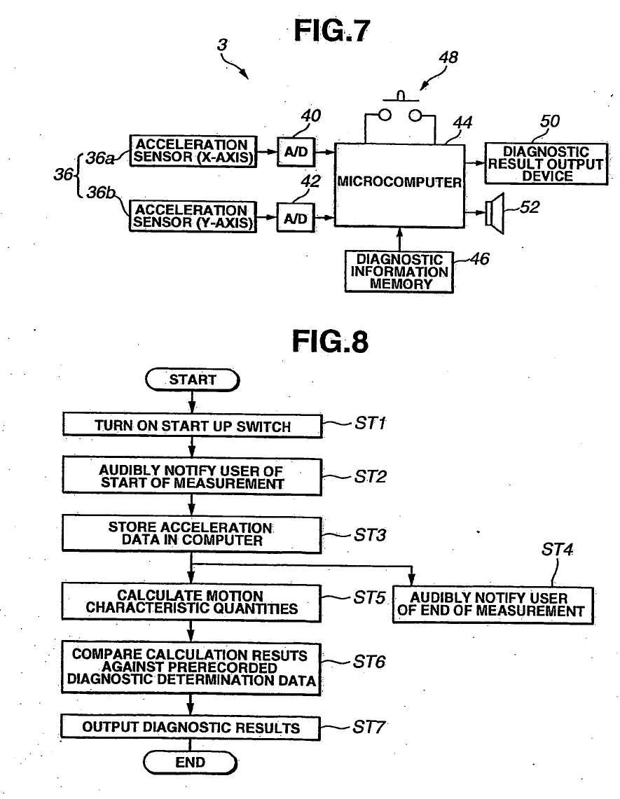

Here follows a description of the functions of the various components of the balance function diagnostic system according to the present invention. FIG. 7 is a functional block diagram illustrating the constitution of a balance function diagnostic system 3 according to the present invention. In the balance function diagnostic system 3 in this figure, acceleration sensors 36 serving as the motion sensor means for detecting motion in the X-axis and motion in the Y-axis are electrically connected to analog/digital converters 40 and 42, respectively, and moreover the analog/digital converters 40 and 42 are electrically connected to a microcomputer 44. In addition, the microcomputer 44 is provided with an electrically connected diagnostic information memory 46, startup switch 48, diagnostic result output device 50 and speaker 52. Here follows a description of the constitution of each.

First, the acceleration sensor 36 serving as the motion sensor means will be described. The acceleration sensor 36 consists of a sensor for detecting motion in the X-axis 36a and a sensor for detecting motion in the Y-axis 36b, thus calculating the acceleration by measuring the forces acting on a weight in the interior of the sensor.

Note that from the standpoint of the object of the present invention which is to diagnose balance function, it is preferable for the acceleration sensor 36 to be mounted on the top of the head as shown in FIG. 5 or at the waist as shown in FIG. 6. For example, by mounting an acceleration sensor on the top of the head, it is possible to measure sway at the top of the head with good reproducibility and low error, without calibrating the relationship between the orientation (angle) and acceleration. In addition, by mounting an acceleration sensor at the waist which is equivalent to the center of the body, random motions that are meaningless in the diagnosis of balance function occur less readily than in the extremities such as the hands or feet and thus highly reliable motion information is obtained. Note that when mounting at the waist, it is preferably mounted at the position of the navel which is near the center of gravity of the human body and positioned along the centerline of the body.

In order to measure the acceleration corresponding to the typical body sway of a healthy person which is 10-20/1000 G (where G is the acceleration due to gravity) with adequate resolution, the acceleration sensor 36 used in the present invention preferably has sufficient resolution to resolve an acceleration of roughly 5/1000 G or less.

Next, the microcomputer 44 will be described. The microcomputer 44 has the function of performing arithmetic processing on the acceleration signals received from the acceleration sensor 36 based on the characteristic quantity data used to determine a diagnosis. Specifically, it has a diagnostic information memory 46 as the motion diagnosis accumulation means that stores information used to determine a diagnosis, and motion diagnosis means (not shown) that analyzes signals received from the acceleration sensor 36 based on the motion characteristic quantity data used to determine a diagnosis, and has the function of providing output of the results of this process to the diagnostic result output device 50 and speaker 52 to be described later.

The diagnostic result output device 50 is a device that provides output of the diagnostic results from the microcomputer 44 to the outside, so that the diagnostic results can be displayed on the screen of a monitor, or the diagnostic results can be printed by a printer or the like on paper media.

The analog/digital converters 40 and 42 are devices that convert the analog signals output from the acceleration sensor 36 into digital signals. The speaker 52 is a device used to convey the start of measurement with a sound, provide voice output of the diagnostic results from the microcomputer 44, provide voice output of operating signals for the operator, and otherwise serve as an auxiliary output of the diagnostic result output device 50. The analog/digital converters 40 and 42 and speaker 52 are not particularly limited in their type, so commercially available units may be used.

In addition, the balance function diagnostic system 3 according to the present invention may also comprise motion storage means that temporarily stores information from the acceleration sensor 36, motion information sending means that sends information from the acceleration sensor 36 wirelessly, and motion information receiving means that receives signals from the motion information transmission means and transmits those signals to the motion diagnosis means.

Here follows a description of one example of information processing by the balance function diagnostic system 3 according to the present invention, made with reference to the flowchart given in FIG. 8.

When the startup switch of the balance function diagnostic system of the present invention is moved to ON (ST1), the balance function diagnostic system starts up and measurement by the acceleration sensor starts several seconds after the startup switch is ON. Thus, it is preferable that the diagnostic apparatus be attached to the body before the startup switch is turned ON. However, the time from startup to the start of measurement can be set appropriately depending on the situation, such as in the case in which the person to undergo diagnosis performs the measurement himself/herself, or the case in which another person operates the apparatus.

The timing of the start/end of measurement can be indicated using a LED or other light, but there are cases in which an optical notification method is not appropriate, such as in the case that the user performs the measurement alone and the main apparatus is not within the field of view of the user or if the user must close their eyes as a condition of measurement. In this case, the start and end of measurement are audibly conveyed to the user in the form of sound effects from the speaker (ST2).

The motion data collected from the acceleration sensor may be the physical characteristic quantities of acceleration, velocity, displacement and frequency components, for example, which are stored in the computer by the motion storage means (ST3). The stored motion data may be stored temporarily and deleted at the time of the end of measurement, or overwritten with newly collected motion data at the time of the next measurement.

Measurement can typically be performed in 30 to 60 seconds, but the measurement time can also be set appropriately depending on the condition of the user. For example, a patient with severe impairment of the brain function may find it difficult to maintain the standing position for a fixed period of time, so the measurement time may be set to the shortest value, or when examining a patient on the first examination for a diagnosis of dizziness or vertigo, it is necessary to determine the degree of dizziness, so the measurement time can be set to the longest value, or other changes are possible.

When the collection of motion data is complete, a sound effect or the like notifies the user of the end of measurement (ST4). At this time, they user may remove the diagnostic apparatus from the body.

At the same time, the microcomputer calculates the motion characteristic quantities of the collected motion data (ST5). As a result, the motion characteristic quantities thus obtained are compared against motion characteristic quantities measured and recorded previously from healthy persons or non-healthy persons with specific disorders of balance function, or namely compared against diagnostic determination data as motion diagnostic information (ST6).

The information obtained as a result of the comparison is output from the diagnostic result output device as diagnostic information (ST7). At this time, the diagnostic information may be displayed on the screen of a display or the like or printed on paper media by a printer or the like.

Note that the measurement may be performed while standing or while sitting, and there is no need for the user to be standing continuously during measurement as is required with a prior-art balance diagnostic apparatus.

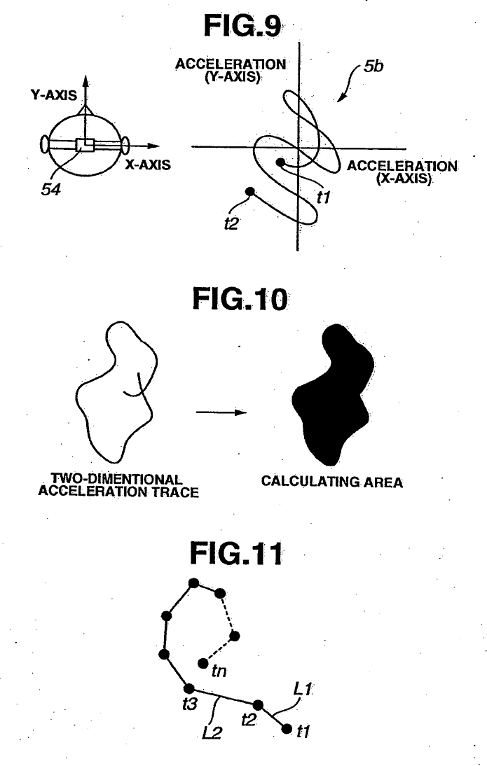

Here follows a description of the method of processing kinetic motion data obtained from the acceleration sensor. FIG. 9 presents a motion trace from a user as obtained from the acceleration sensor. In the illustrated example, the mounting location of the acceleration sensor is the top of the head as shown in FIG. 5.

When an acceleration sensor 54 is mounted on the top of the head of a person, the left/right sway (lateral sway) in the X-axis direction in FIG. 9(a) are detected, and the anterior/posterior sway (longitudinal sway) in the Y-axis direction in FIG. 9(b) are detected. FIG. 9(b) illustrates the value of the acceleration over time as a trace pattern. In this figure, from the acceleration value at time t₁ and the acceleration value at time t₂, it is possible to find a characteristic quantity that indicates how much the axis of the body has swayed over a fixed period of time.

FIG. 10 illustrates an example of finding the surface area based on the acceleration trace pattern described above. As shown in this figure, the length of the outermost periphery is calculated from the two-dimensional acceleration trace. Then, the surface area of the range enclosed by the outermost periphery (the blackened-out range) is found to find a characteristic quantity that represents how much the head of the user swayed over how much of a range at most.

In addition, it is also possible to find the kinetic energy amount necessary to move the head of the user. FIG. 11 presents an example of finding the total trace length from the acceleration trace pattern. The trace of acceleration is plotted over time from the time t₁ to t₂, t₃, . . . tₙ, and the distances between the plotted points are found as the trace lengths L₁, L₂, . . . . Moreover, as illustrated below, by adding up the length L₁ of the acceleration trace from time t₁ to time t₂, the length L₂ of the acceleration trace from time t₂ to time t₃, . . . the length of the acceleration trace from time tₙ₋₁ to time tₙ, it is possible to find a characteristic quantity indicating just how much kinetic energy is used to move the head of the user during the measurement time (the total trace length).
total trace length=length L₁ of the acceleration trace from time t₁ to time t₂+length L₂ of the acceleration trace from time t₂ to time t₃+length of the acceleration trace from time tₙ−1 to time tₙ (3)

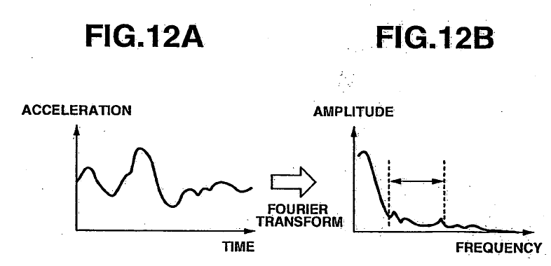

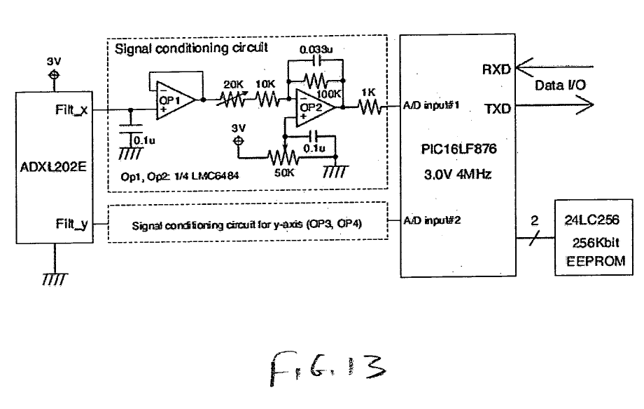

Moreover, when as a result of measurement, the relationship between time and acceleration takes the form of the graph in FIG. 12(a), if a Fourier transform is performed from the time signal f(t) to the frequency function F(ω), a graph illustrating the relationship of the amplitude to the frequency such as that in FIG. 12(b) is obtained. In this graph, it is possible to find the vibration energy over a stipulated range of frequencies (the range indicated by arrows) as a characteristic quantity. Note that this characteristic quantity can be found for both the X-axis and the Y-axis.

The balance function diagnostic apparatus and system according to the present invention may be described in the case of being used to measure the balance function of a human, but the balance function diagnostic apparatus and system according to the present invention can also be applied to a standing two-legged walking-type robot. In this case, by subjecting the information obtained from the motion sensor to information processing by the microcomputer and by reflecting the diagnostic results in the operation of the hands and feet or other extremities, it becomes possible to form a posture that will prevent the robot from toppling over. Even in the case that the robot should topple, it is also possible to send the robot commands to form a posture that will minimize the shock upon toppling.

In addition, the balance function diagnostic apparatus and system according to the present invention performs measurements using an acceleration sensor or other motion sensor mounted upon a portion of the body, so the presence of gravity is not assumed as in the case of the scale-type measurements according to the prior art, and there are also no limitations on location. Thus, it can also be used in a zero-gravity environment such as that in space.

As described above, by having the user wear motion sensor means upon their body and calculating the characteristic motions of parts of the body related to the balance function, it is possible to achieve a balance function diagnostic apparatus and system that can be used by anyone at any time or any place, which is difficult with the prior art.

In addition, because of the characteristic of the apparatus and system according to the present invention of being able to be used at any time or any place, the user can perform daily diagnosis of the balance function with no necessity for the user to go to a medical facility, so the state of health can be easily determined on an everyday basis.

In addition, dizziness or vertigo becomes a major problem in space, but the apparatus and system according to the present invention can be used even in a zero-gravity environment such as that of space.

The wearable system can be implemented for detecting accelerations of the user's head while standing still for the purpose of developing a daily health care application. A 2-axis accelerometer may be attached on the top of the user's head to separately detect faint accelerations in both the front to back and right to left directions. The total weight of the headset device may be only 195 grams including a 9V NiMH battery. Healthy subjects may be observed under normal conditions and record typical accelerations in the range of 10-30 milli-Gs, which may be sufficient to be detected by the system's sensitivity. Numerical analysis may be performed on traces of acceleration patterns for a specific user in different conditions. From analysis it may be found that a total length of 2-dimensional acceleration pattern trace and a high frequency spectrum (2 Hz-10 Hz) of right/left acceleration may related to the physical condition of the user. The wearable headset device can be carried to anywhere the user goes and the diagnosis of the wearer's physical condition only requires that the user stand still for 30 seconds, showing that this system can be used for daily health care monitoring.

The sense of balance is maintained by various kinds of nervous system with specific sensing organs as follows: (1) The inner ears, which detect the directions of motion; (2) The eyes, which locate one's body is in space and determine direction of motion; and (3) The force receptors such as the sense of touch. There may be a complex interaction between these sensing organs to maintain one's sense of balance. If even one of them sends inappropriate signal, one may loose the balance sense and feels some dizziness. For example, a lack of blood flow may cause functional disorders in sensing organs. Emotional stress may affect blood circulation. Viruses causing cold or flu may harm the inner ears. Also when a person is tired, they sometimes feel dizziness, which can cause irregularities in balance.

There are various candidate positions on the body that may be suitable to estimate the deviation of COG, for example, top of the head, around the ears, around the waist, and so on. In some locations on the head, the sensors may detect the motion of head instead of the COG of the whole body. Torso-worn motion sensors may estimate the position of COG more accurately because the sensors are attached close to the COG of the body. The torso-worn solution may, however, include body motion due to breathing and the fact that some types of clothing may be inappropriate for the measurement in terms of daily use. On the other hand, a headset-based implementation also has both advantages and disadvantages. When the measurement is performed while the user is standing still, the swing of vibratory motion becomes to be largest at the top of the head, and the sensitivity of the measurement is maximized because the top of the head is the farthest position from the fulcrum, i.e. the soles. The magnitude of acceleration may be almost comparable to the noise floor of commercially available sensor devices, the maximum sensitivity may be thought to be inevitable. In addition, a headset device can be freely attached and detached from the user's head. As compared to the torso-worn device, the user's choice of clothes is has less affect on the measurement. A potential disadvantage of the headset device is distinguishing head motion from COG changes. Like arms and feet, the head can move freely to some extent. The relative position of the head to the whole body may not affect to the position of COG very much. The motion of the head and the position of COG may be strongly correlated from observations of the stabilometry diagnosis in the hospital.

Analog Device's integrated 2-axis accelerometer, model number ADXL202E, may be used for the motion sensing device. The noise floor of the ADXL202E can be reduced to less than 2 milli-Gs for a 50 Hz bandwidth, which is sufficient bandwidth for the stabilometry using the force plate. The supply voltage may be set to be 3.0V to minimize power consumption without losing the reliability of measurement circuit.

FIG. 13 shows a diagram of the circuit design. In the design, the analog operational amplifier circuits for both axes arrange the voltage signal of acceleration is as follows: (1) Zero-G offset voltage=1.50V; (2) Voltage; sensitivity=1.0V/G (G˜9.8 m/s ); (3) Voltage resolution=10 bit (2.9 mV: 2.9 mG); (4) Bandwidth=50 Hz (−3 dB). The accelerometer (ADXL202E) has a fairly large zero-G offset voltage as well as an unevenness of voltage sensitivity, therefore analog signal conditioning circuits (shown in FIG. 13) are used to minimize computational power. Microchip Corp's PIC16LF876 microcontroller may be used for the digital signal processor because it is small and has sufficient peripheral ports such as a 10-b analog-to-digital (AID) converter with 5 channel multiplexer, a 2-wire serial interface to communicate with a 256-Kbit flash EEPROM, and a hardware serial port which can be connected to an external computer for further data analysis.

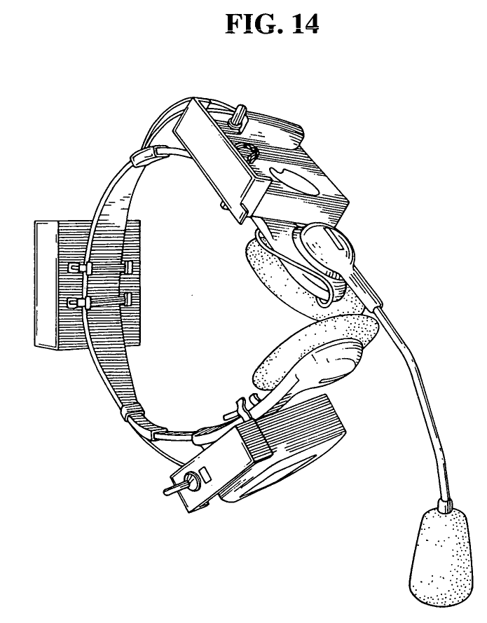

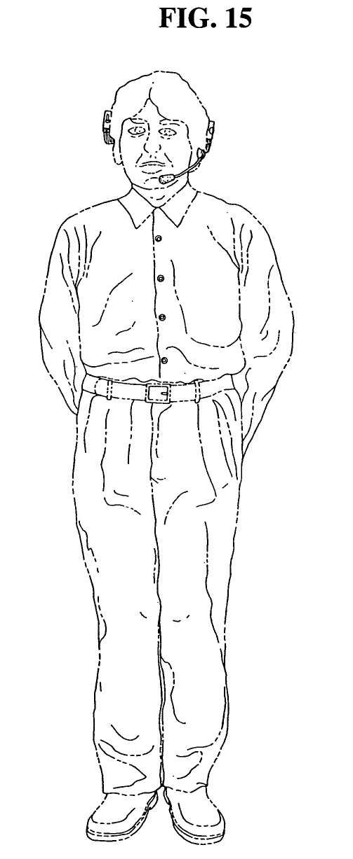

FIG. 14 shows a photograph of an exemplary headset device. The sensory and microcontroller circuits are attached on the top of the head. The headset includes a 9V NiMH (150 mAh) battery and a power switch, but other power supplies may be used. The headset may also include an electronic sound circuit and a loud speaker positioned to notify the user when the measurement starts and ends. The whole headset device may weigh only 195 grams, including the battery. The power consumption for measurement is about 30 milliwatts (3V 10 mA) without the power-consuming electronic sound module. The sampling period of the acceleration measurement may be set to be 10 milli-seconds, which corresponds to the 50 Hz bandwidth of analog signal. To evaluate the noise floor of the device, a measurement may be performed while the device is affixed to a firm object. During this baseline measurement, 3LSB peak-to-peak shot noise may be observed in the form of 10-b A/D converted digital reading for each axis, which corresponds to about 8.8 milli-G of acceleration. The RMS noise may be around 1.3 to 2.2 milli-G. To remove the shot noise from the data, smoothing with a 10-point median filter may be performed on the sampled data. In this case, the analysis bandwidth may be reduced to 10 Hz.

FIG. 15 shows a typical setup of the sense of balance diagnosis system with the developed headset device. To maximize the sensitivity to the body's motion, the acceleration measurement axes are placed in the plane parallel to the ground. The x-axis may correspond to left/right acceleration and the y-axis to front/back acceleration. Because the accelerometer ADXL202E has sensitivity to the static gravity, the acceleration data signal from the device contains the information on the tilt angle towards the ground. The measurement time may be set to 30 seconds, the minimum time for the existing stabilometry diagnosis procedure authorized in Japan. Two measurements were taken, one with the wearer's eyes open and one with the user's eyes closed. To minimize artifacts, the headset device may be operated in a standalone fashion during acceleration measurement.

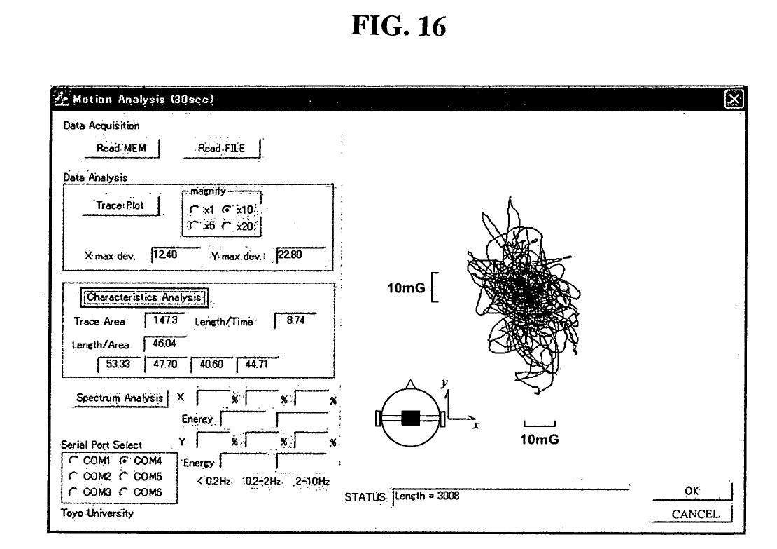

FIG. 16 shows a typical measurement trace of a two dimensional acceleration plot for 30 seconds. The trace corresponds to the movement of the head viewed from overhead. The maximum acceleration seen in y-axis may be calculated to be about 22 milli-Gs, which is almost one order of magnitude larger than the noise floor (RMS) level. Accelerations were typically observed in the range of 10˜30 milli-Gs for normal healthy people (ages 20 to 50). On the other hand, the magnitude of shot noise from the accelerometer lies in the order comparable to the maximum acceleration value. A median filter may be utilized to remove the noise. Referring to the results from the existing stabilometry diagnosis, the portion of frequency spectrum portion above 10 Hz may be hardly used in analysis. Therefore, the number of points for median filtering may be set to be 10, which corresponds to the bandwidth of 10 Hz at the sampling period of 10 milliseconds. To parameterize the acceleration patterns, the following calculation may be performed on the data obtained on an external notebook computer connectable to the headset device. These parameterization methods were originally from the stabilometry diagnosis.

It should be noted that the physical quantity measured by the headset device may not be exactly the same as the change in the position of COG in the following ways: (1) Maximum deviation of acceleration in each axis—as the acceleration signal contains the information on the tilt angle of the sensor as an offset, a sort of high-pass filtering is required to estimate the magnitude of motion; (2) Area of 2-dimensional acceleration trace pattern—in addition to the maximum deviation of acceleration, the area of acceleration trace may have information on the total intensity of motion; (3) Total length of 2-dimensional acceleration trace—by assuming constant mass of the subject, the total length of 2-dimensional acceleration trace corresponds to a total kinetic energy—the force [N] applied to the constant mass [kg] is proportional to the acceleration [M/s²]—as the time integral of the force becomes to be energy [J], the summation of the acceleration fragments within the sampling time period over the whole measurement time corresponds to the total kinetic energy; and (4) Frequency spectrum of acceleration in each axis—Fourier transform calculation is performed over the whole acceleration signal in each axis—although the motion of body is not periodic, the spectrum gives some information on how fast the body moves.

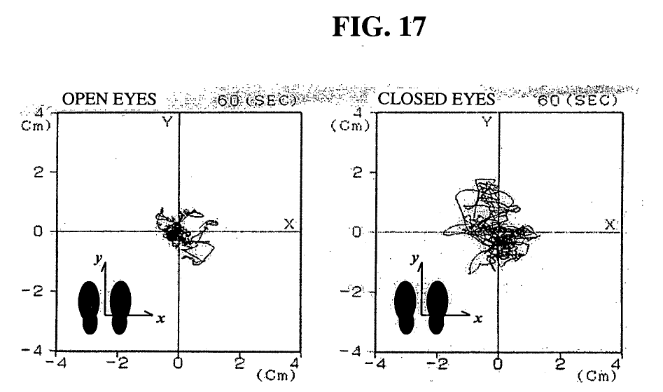

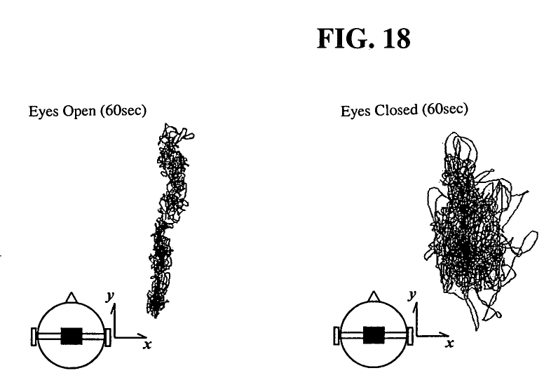

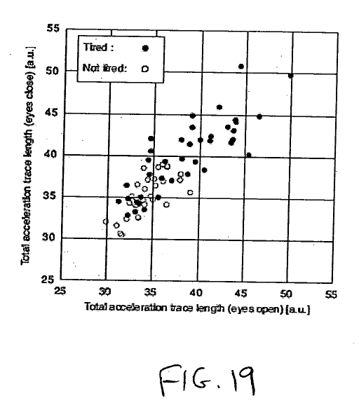

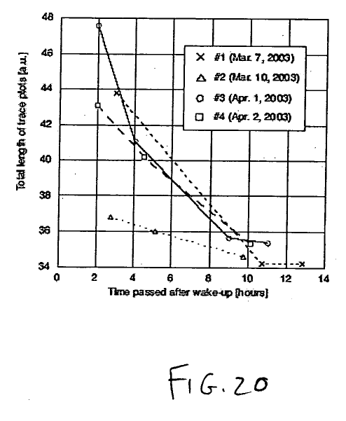

FIG. 17 shows the trace of the estimated COG position derived from the stabilometry method and FIG. 18 shows the trace of acceleration plots obtained by the headset device. As described earlier, the headset device may detect a different physical quantity from the existing stabilometry method. FIGS. 17 and 18 illustrate both devices being operated at the same time. Although these measurements may be taken at almost the same time, the shape of trace pattern differs especially for the case of eyes open. This discrepancy may be explained by the difference in the kind of physical quantity being measured. For example, aside from COG, the force plate also measures intentional pressure from the sole of the user's foot, which is produced to maintain balance. The headset device does not detect this foot pressure, however the headset device does also measure the tilt angle of the user's head. In changes in the tilt angle towards the ground may reach 3 degrees, which corresponds to about 52 milli-Gs. As the acceleration value is much larger than that of typical vibratory motion, the change in the tilt angle may be observed in the case of eyes open in FIG. 18. In contrast to the headset device, the force plate detects basically the COG of the whole body, and it does not measure the tilt angle of the head. On the other hand, the sense of balance and the tilt angle of the head are closely related. From this point of view, it can be that the headset device has high sensitivity for diagnosing the sense of balance. Because of the complexity in the nerve reflex mechanism, clinical data may be collected to try to find a relationship between the measured acceleration patterns and the conditions of the user.

In order to evaluate how the calculated parameters are affected by the conditions of the user, daily measurements may be performed on a specific user while recording comments about the user's physical condition. Each measurement may include six, thirty seconds runs, three runs with eyes open and three runs with eyes closed to check the reproducibility of the measurement. All measurements may take place in a closed and quiet room over a period of two months. After closely examining the parameters for a wide variety of situations and reproducibility tests, the following may be discovered: (1) Sometimes the 2-dimensional acceleration pattern becomes lengthened in front/back direction as seen in FIG. 18 (eyes open). This may be accounted for by the tilt angle of the head towards the ground changing slowly and irreversibly as mentioned before. In this case, the value of trace pattern area may increase significantly. On the other hand, total length of pattern trace may not vary very much as the shape of the pattern becomes more oblong. (2) The lower portion (<1 Hz) of frequency spectrum may not show satisfactory reproducibility for diagnosis. This may also be explained by the slow changes in the static tilt angle of the user's head during the measurement. (3) The higher frequency potion of the spectrum also may not show a specific pattern related to the user's condition, as the motion of the body to maintain balance is produced by some chaotic process in the nerve reflex mechanism. (4) The total length of acceleration trace may show both reproducibility and relationships to the user's condition. When the user feels tired due to the lack of sleep, cold or flu, just after some tiresome meeting, and so on, the value of total trace length may increase considerably.

FIG. 19 is a chart illustrating trace length versus tiredness. From the above-mentioned observations, sample data may be collected on the total trace length of acceleration plots and the user's conditions as shown in FIG. 19. The closed circles correspond to tired conditions and the open circles correspond to non-tired or normal conditions. Although it may be difficult to express the degree of tiredness in quantitative terms, the total length of the acceleration plots and the degree of tiredness may be correlated. The total length may decrease with the amount of the time since the user woke up.

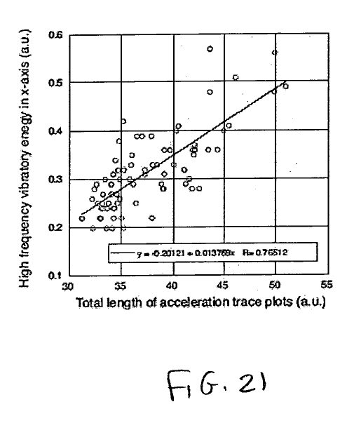

FIG. 20 shows some series of the total length data when the user's eyes are closed. Each series may be taken on the same day. For series #3, the user may have slept for only 3 hours. For the #1 and #4 series, the user may have had a cold. A similar tendency can be observed in the series #2 when the user may not have had any trouble in physical condition. The observations of this tendency may make a health diagnosis based on sense of balance diagnosis more reliable.

Additionally, measurements may be performed after some stressful events in which the user felt tired, for example, just after a time-consuming meeting (3 hours) in the evening. After the meeting, the total length values may be 43.0 and 43.6 in the case of eyes open and closed respectively. After taking a rest for 2 hours, the values may decrease to 35.4 and 38.7. Consuming an alcoholic drink at night may make the values increase to 46.3 and 44. 1, which are larger as compared to the usual values, around 30-35. The calculation of the total length of trace may be performed with a notebook PC in the experiment. However, the whole monitoring system can be fully wearable because the calculation is quite a simple and can be implemented within a low-power microcontroller.

By looking at the results from the frequency spectrum calculation on acceleration in each axis, there may be a fairly good reproducibility in higher frequency (>2Hz) portion even if the tilt angle of the head towards the ground changed drastically. This phenomenon may be explained by the fact that the changes in the tilt angle occurred very slowly and did not affect the higher frequency portion of the spectrum. As the behavior of the tilt angle may occasionally change drastically even in the same measurement series, it may be desirable to have reproducible parameters that are robust to tilt. First, a calculation algorithm may be considered to evaluate the degree of vibratory motion in the high frequency region. As an analytical model, a simple harmonic oscillator having a constant mass M may be assumed. A vibratory motion at the frequency of w may be written as:
x=D sin(wt)−(1), (4)
where x is the deviation distance from the origin, t is the elapsed time, and D_{w} is the amplitude.

By taking the first and second derivative of the equation Total length of acceleration trace plots (a.u.) (1), we obtain the corresponding velocity v and acceleration acc.
v=D_{w}w cos(wt) (5)
acc=−D_{w}w² sin(wt) (6)

From the equation (5), we can calculate the time-averaged kinetic energy Ew as:

$${E}_{w} = \frac{1}{2} M < v {>}^{2} = {KD}_{w}^{2} {w}^{2} \qquad ( 7 )$$

where the K is constant. In our experiments we obtain the frequency portion of acceleration Aw as Aw=Dww2. Therefore, the kinetic energy Ew can be expressed as:
E_{w}=K D_{w}²w²=K A_{w}²w² (8)

Consequently, the kinetic energy may be expressed as the function of the amplitude of acceleration frequency spectrum, Aw, using the principle of superposition.

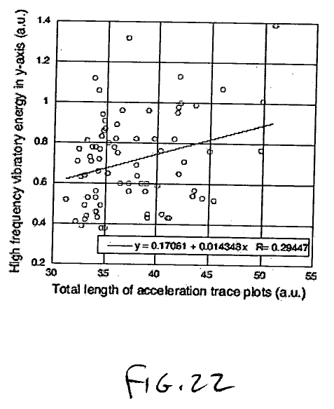

FIG. 21 shows the relationship between the total length of acceleration trace plots (2-dimensional) and the total kinetic energy for the frequency range of 2Hz-10 Hz in x-axis (right/left motion). As seen in FIG. 21, there may be a high positive relevance. The plot demonstrates that the value of x-axis high frequency energy may provide information on the user's condition, in addition to the total length analysis.

FIG. 22 shows the total trace length versus a y-axis high frequency portion of kinetic energy. There may not be an obvious positive relevance between the total length and the energy in y-axis. Although the physiological mechanism of this phenomenon may not be clear, the plot shows yet another diagnosis parameter other than the total length of acceleration trace plots.

Therefore, a headset-based motion analysis system may be designed having a sufficient sensitivity to detect an ordinary person's vibratory motion while standing still. The environmental requirement for the diagnosis may be only a measurement space where the user can stand still for a determined time, such as thirty seconds. Although the headset device measures different physical quantities compared to the existing balance of sense diagnosis system based on force distribution measurement at the user's sole, the total length of acceleration trace plots and the x-axis kinetic energy portion of high frequency region measured with the headset device may display something related to the user's condition. The wearable balance of sense monitoring system may provide for daily health care monitoring.

Experiments with the headset-based sense of balance monitoring system may include: (1) Population tests with a wide variety of healthy people as well as a wide variety of conditions to make the proposed system reliable and quantitative. A combination with other quantitative method such as flicker test (eye fatigue method) may improve the system's reliability. (2) Clinical data may be collected from a wide variety of patients. The headset-based measurement may give different motion signals compared to the existing force plate device in hospitals. A sufficient amount of data corresponding to some specific diseases or symptoms may be collected to compare the two more completely. Unlike the force plate based diagnosis, the headset-based device may be applicable to the patients who are not able to stand still even for thirty seconds due to their difficulties. For example, if a patient can sit down onto a bed, the headset device may diagnose their sense of balance from that position. (3) A methodology may be used to measure the tilt angle of the user's head and head motion separately while maintaining a sufficient sensitivity and background noise level. For example, a combination of accelerometer and gyro may solve this, however, commercially available gyro sensors with a satisfactory form factor may not have sufficient noise specifications. Gyro sensors with satisfactory form factors may be used. The gyros may also have a fairly large offset voltage drift. A calculation of the tilt angle by integrating the output from such a gyro (angular velocity) may have somewhat meaningless results. (4) The number of users wearing the headset device may be increased. The device may become a ubiquitous diagnosis system for everyone. Preliminary experiments may show that the total length of acceleration trace plots tends to be larger for younger people. As well as collecting the data, it may be determined how to motivate users to want to wear the headset. A possible motivation may be to combine the balance-monitoring device with another useful device such as a headphone stereo. (5) The environmental requirement for measurement may be investigated. The headset device may not be sensitive to vibratory motion. Requirements for the measurement environment and make a guideline to maintain the reliability of diagnosis may be implemented.

In addition, the diagnostic apparatus and system according to the present invention may also be utilized to perform quantitative evaluation of the balance function. Other evaluation include evaluation of the gravity of balance disorders, evaluation of the degree of improvement of balance disorders, evaluation of the effectiveness of treatment, as an index of development of the balance function. The diagnostic apparatus may also be used for inferring the damaged organ causing balance disorder, etc.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

We claim:

1. A balance function diagnostic system comprising:
a motion sensor wearable on a user that detects bodily motion of the user; and
a motion analyzer that analyzes signals from the motion sensor based on prerecorded motion diagnosis information and performs diagnosis of balance function of the user.

2. A balance function diagnostic system according to claim 1, wherein the bodily motion is detected as any of a velocity, an acceleration, an angular velocity and a frequency.

3. A balance function diagnostic system according to claim 1, wherein the motion analyzer is placed separately from the use and wirelessly connected to the motion sensor.

4. A balance function diagnostic system according to claim 1, wherein the motion sensor is provided with a motion storage wearable on the user that stores the signals from the motion sensor.

5. A balance function diagnostic system according to claim 1, wherein the prerecorded motion diagnosis information is obtained from healthy persons.

6. A balance function diagnostic system according to claim 1, wherein the prerecorded motion diagnosis information is obtained from non-healthy persons.

7. A balance function diagnostic system according to claim 1, further comprising a stimulus generator that applies a sensory stimulus to the user.

8. A balance function diagnostic system according to claim 7, wherein the sensory stimulus comprises a visual stimulus.

9. A balance function diagnostic system according to claim 8, wherein the visual stimulus comprises moving images projected on a screen.

10. A balance function diagnostic system according to claim 8, wherein the visual stimulus comprises a light emitted at varying intensity.

11. A balance function diagnostic system according to claim 7, wherein the sensory stimulus comprises an auditory stimulus.

12. A balance function diagnostic system according to claim 7, wherein the sensory stimuli comprise a physical stimulus that is exerted on the user.

13. A balance function diagnostic system according to claim 1, wherein the motion sensor is attached to the head of the user.

14. A balance function diagnostic system according to claim 1, wherein the motion sensor is attached to the waist of the user.

15. A balance function diagnostic system according to claim 1, wherein the motion sensor comprises an acceleration sensor sensitive to gravity.

16. A balance function diagnostic system according to claim 1, wherein the motion sensor comprises a gyro sensor.

17. A balance function diagnostic system according to claim 1, wherein low-frequency components are removed from the signals from the motion sensor before they are analyzed.

18. A balance function diagnostic system according to claim 1, wherein signal components resulting from a change in posture of the user are removed from the signals from the motion sensor before they are analyzed.

19. A balance function diagnostic system according to claim 1, wherein the motion sensor measures motions in two directions in a plane.

20. A balance function diagnostic system according to claim 1, further comprising a diagnostic output device that outputs diagnostic results from the motion analyzer.

21. A balance function diagnostic system according to claim 20, wherein the diagnostic results comprise a two-dimensional trace pattern representing motion of the user over a time.

22. A balance function diagnostic system according to claim 21, wherein the diagnostic results comprise a calculated area encompassed by the trace pattern.

23. A balance function diagnostic system according to claim 21, wherein the diagnostic results comprise a total trace length of the trace pattern.

24. A balance function diagnostic system according to claim 21, wherein the diagnostic results comprises energy spent in the detected motion.

25. A balance function diagnostic system according to claim 1, wherein the motion sensor detects bodily motion of the user being in a sitting position.

26. A balance function diagnostic system according to claim 1, further comprising a sensory signal output device that output a sensory signal to the user when a start and/or an end of detecting bodily motion of the user.

27. A balance function diagnostic system according to claim 26, wherein the sensory signal output device is a speaker.

28. A balance function diagnostic system according to claim 26, wherein the sensory signal output device is an LED.

29. A balance function diagnostic system comprising:
a motion sensor wearable on a user that detects bodily motion of the user;
a stimulus generator that applies a sensory stimulus to the user; and
a motion analyzer that analyzes signals from the motion sensor and performs diagnosis of balance function of the user.

30. A balance function diagnostic system according to claim 29, wherein the bodily motion is detected as any of a velocity, an acceleration, an angular velocity and a frequency.

31. A balance function diagnostic system according to claim 29, wherein the motion analyzer is placed separately from the use and wirelessly connected to the motion sensor.

32. A balance function diagnostic system according to claim 29, wherein the motion sensor is provided with a motion storage wearable on the user that stores the signals from the motion sensor.

33. A balance function diagnostic system according to claim 29, wherein the sensory stimulus comprises a visual stimulus.

34. A balance function diagnostic system according to claim 33, wherein the visual stimulus comprises moving images projected on a screen.

35. A balance function diagnostic system according to claim 33, wherein the visual stimulus comprises a light emitted at varying intensity.

36. A balance function diagnostic system according to claim 29, wherein the sensory stimulus comprises an auditory stimulus.

37. A balance function diagnostic system according to claim 29, wherein the sensory stimulus comprises a physical stimulus that is exerted on the user.

38. A balance function diagnostic system according to claim 29, wherein the motion sensor is attached to the head of the user.

39. A balance function diagnostic system according to claim 29, wherein the motion sensor is attached to the waist of the user.

40. A balance function diagnostic system according to claim 29, wherein the motion sensor comprises an acceleration sensor sensitive to gravity.

41. A balance function diagnostic system according to claim 29, wherein the motion sensor comprises a gyro sensor.

42. A balance function diagnostic system according to claim 29, wherein low-frequency components are removed from the signals from the motion sensor before they are analyzed.

43. A balance function diagnostic system according to claim 29, wherein signal components resulting from a change in posture of the user are removed from the signals from the motion sensor before they are analyzed.

44. A balance function diagnostic system according to claim 29, wherein the motion sensor measures motions in two directions in a plane.

44. A balance function diagnostic system according to claim 29, further comprising a diagnostic output device that outputs diagnostic results from the motion analyzer.

45. A balance function diagnostic system according to claim 44, wherein the diagnostic results comprise a two-dimensional trace pattern representing motion of the user over a time.

46. A balance function diagnostic system according to claim 45, wherein the diagnostic results comprise a calculated area encompassed by the trace pattern.

47. A balance function diagnostic system according to claim 45, wherein the diagnostic results comprise a total trace length of the trace pattern.

48. A balance function diagnostic system according to claim 45, wherein the diagnostic results comprises energy spent in the detected motion.

49. A balance function diagnostic system according to claim 29, wherein the motion sensor detects bodily motion of the user being in a sitting position.

50. A balance function diagnostic system according to claim 29, further comprising a sensory signal output device that output a sensory signal to the user when a start and/or an end of detecting bodily motion of the user.

51. A balance function diagnostic system according to claim 50, wherein the sensory signal output device is a speaker.

52. A balance function diagnostic system according to claim 50, wherein the sensory signal output device is an LED.

53. A method of diagnosing a balance function, comprising the steps of:
attaching a motion sensor to a bodily part of a user;
detecting by the motion sensor accelerations of bodily motion of the user;
analyzing the detected accelerations to recognize them as a trace pattern; and
calculating a total trace length of the trace pattern.

54. A method of diagnosing a balance function, comprising the steps of:
attaching a motion sensor a bodily part of a user;
applying a sensory stimulus to the user;
detecting by the motion sensor accelerations of bodily motion of the user; and
analyzing the detected accelerations to quantify the bodily motion of the user.

55. A method according to claim 54, wherein the sensory stimulus comprises a visual stimulus.

56. A method according to claim 55, wherein the visual stimulus comprises moving images projected on a screen.

57. A method according to claim 55, wherein the visual stimulus comprises a light emitted at varying intensity.

58. A method according to claim 54, wherein the sensory stimulus comprises an auditory stimulus.

59. A method according to claim 54, wherein the sensory stimulus comprise a physical stimulus that is exerted on the user.
